(19) United States
(12) Patent Application Publication
(10) Pub. No.: US 2005/0190699 A1
(43) Pub. Date: Sep. 1, 2005

(54) Collecting hardware asset information

(76) Inventors: Carey W. Smith, Hillsboro, OR (US); David Hines, Hillsboro, OR (US)

Correspondence Address: TROP PRUNER & HU, PC, 8554 KATY FREEWAY, SUITE 100, HOUSTON, TX, 77024, US

(21) Appl. No.: 10/787,624

(22) Filed: Feb. 26, 2004

(51) Int. Cl. H04L 12/26

(52) U.S. Cl. 370/241; 370/254

(57) ABSTRACT

Network coupled processor-based systems may collect asset information. That information may be reported even when those systems are non-operational. The information may be utilized to provide information back to those systems, to diagnose problems, to provide repair, and to push system specific diagnostics and software to particular systems over a network.

### BACKGROUND

This invention relates generally to the maintenance of processor based systems accessible over a network.

Processor based systems such as personal computers, cellular telephones, entertainment systems, and the like may be coupled for communications over networks. These networks may include the Internet as one example as well as local area networks and other networks.

In one example, corporate information technology departments may manage a large number of computers. To this end, those departments must service a large number of individual computers, dispersed over a large area.

Conventionally manufacturers of the personal computers provide some type of warranty or service. The service may require a technician to travel to the site of the processor based system or conversely for the owner or user of the processor based system to bring it to a service location. The downside of these approaches includes considerable down time in obtaining service.

Thus there is a need for better ways to maintain, service or update processor based systems.

### BRIEF DESCRIPTION OF THE DRAWINGS

FIG. 1 is a schematic depiction of a networked arrangement in accordance with one embodiment to the present invention;

FIG. 2 is a schematic depiction of a processor based system shown in FIG. 1 in accordance with one embodiment to the present invention;

FIG. 3 is a flowchart for software utilized on the system shown in FIG. 2 in accordance with one embodiment to the present invention;

FIG. 4 is a flowchart for software used on the management framework shown in FIG. 1 in accordance with one embodiment to the present invention;

FIG. 5 is a depiction of the software interaction between the controller 34 and the processor 18 in accordance with one embodiment of the present invention; and

FIG. 6 is a flowchart showing how collected information is reported.

### DETAILED DESCRIPTION

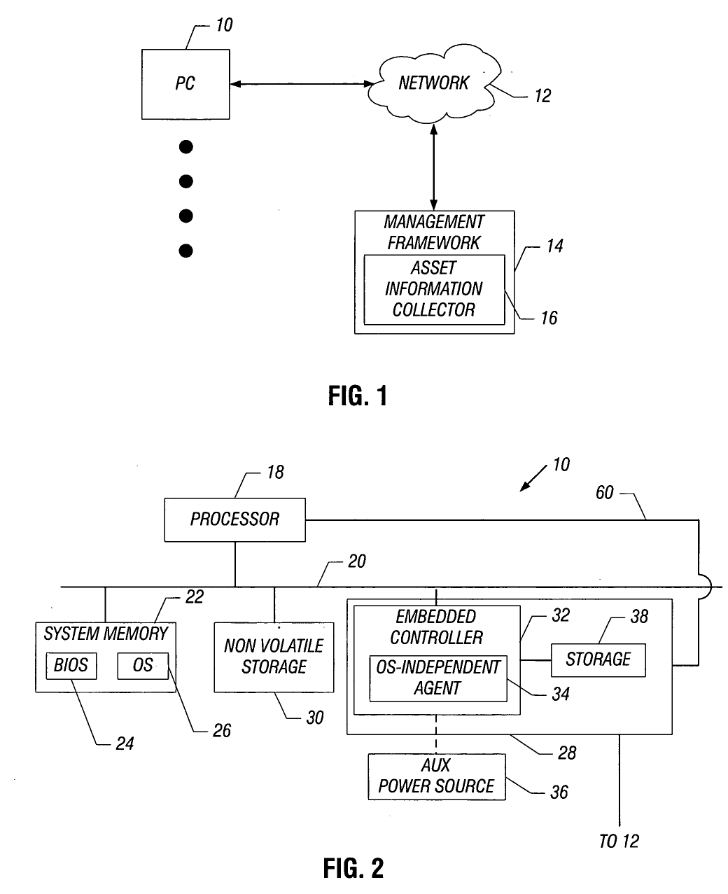

Referring to FIG. 1, a number of processor-based systems 10, such as personal computers, may be coupled over a network 12, such as the Internet or a local area network, as two examples. The processor based systems 10 may be accessed by a management framework 14 such as a server. The management framework 14 may include an asset information collector 16 whose function is to obtain information about the status of the processor based systems 10 coupled to the network 12. This information may be utilized to diagnose hardware and software problems, to repair systems, and to assess deployment usages.

The systems 10 may be any processor-based system. They may be part of a wired or a wireless network. The systems 10 may be, for example, desktop or laptop computers, servers, personal digital assistants, cellular telephones, or entertainment systems, to mention a few examples.

Referring to FIG. 2, the processor based system 10 may, in one embodiment, include a processor 18 coupled to a bus 20. The bus 20 may in turn be coupled to a system memory 22. The system memory 22 may store an operating system 26 and a basic input/output system (BIOS) 24 when the system 10 is operational. The system memory 22 may be a volatile memory in one embodiment of the present invention.

The bus 20 may also couple to a local area network (LAN) controller 28 which allows connections to the network 12. The controller 28 may enable wired or wireless connections. Also coupled to the bus 20 may be a non-volatile storage 30. The non-volatile storage 30 may be any non-volatile memory, such as a flash memory, a hard drive, or an optical disk drive, to mention a few examples.

In one embodiment of the present invention, the controller 28 may include an embedded controller 32. The embedded controller 32 may be a microcontroller storage having an operating system independent agent 34 that operates with the system BIOS 24 to collect information about a particular processor based system 10. The controller 32 may be associated with a storage 38.

To enable the embedded controller 32 to operate when the processor based system 10 is in a power saving mode or power off mode, an auxiliary power source 36 may be provided for the embedded controller 32. The auxiliary power source 36 may be operational at all times and may be recharged, in one embodiment, when the processor based system 10 is in a power on state.

The controller 28 may couple to the network 12. The controller 28 may also be coupled to a system management bus (SMBus) 60. The bus 60 may be coupled to the processor 18.

While one architecture for the processor based system 10 is illustrated in FIG. 2, those skilled in the art will appreciate that any architecture may be utilized. That is, no one particular architecture is central to the present invention. While an embedded controller 32 is utilized, other techniques may be utilized as well including the use of an operating system independent execution thread running on the processor 18.

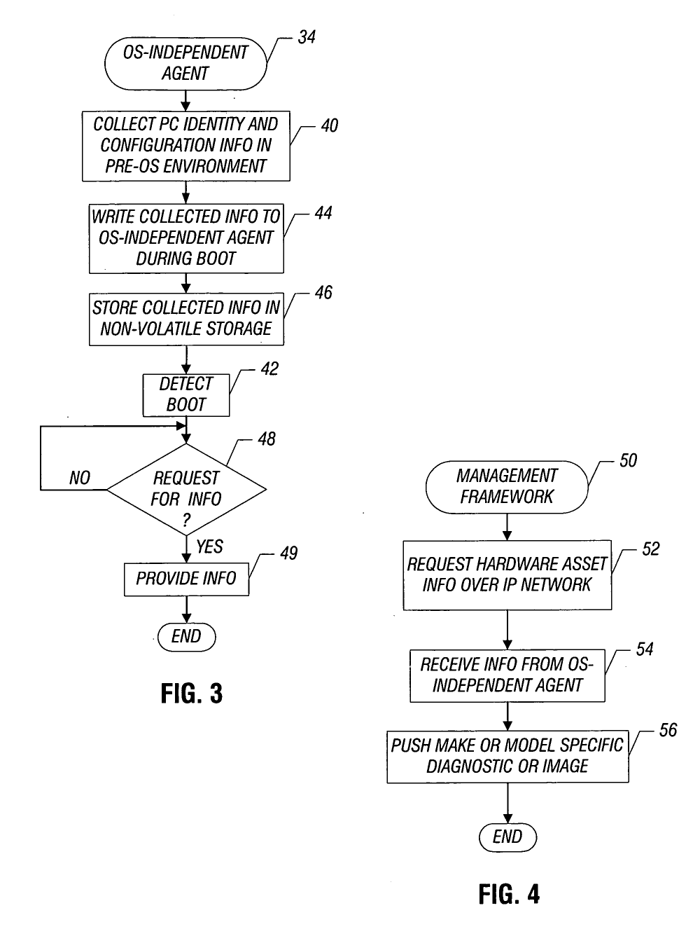

Referring to FIG. 3, in one embodiment, while the system 10 is operational, the operating system independent agent 34 may initially collect information about the identity of the particular processor based system 10 as indicated in block 40. Examples of collected asset information may include a processor identification number, a system global unique identifier derived from a medium access control address, manufacturer, make, and model of the system 10, serial number, processor information, such as the processor type and family, list of memory chips on the system 10, and the make and model of the hard disk drive. This information may be obtained from a table in the BIOS 24 in one embodiment. The configuration information may include various registry settings as well as information about the various peripherals and components that make up the system 10.

The agent 34 may also collect configuration information about the system 10 and its environment before the operating system boots. This information may then be used to diagnose initialization errors also reported over the network 12 to the management framework 14.

The agent 34 stores the collected information in the non-volatile storage 38 as indicated in blocks 44 and 46. After detecting system boot (block 42), when the agent 34 receives a request for information, as determined in diamond 48, from the management framework 14, the agent 34 provides the information as indicated in block 49. Since the agent 34 may operate using the auxiliary power source 36, the agent 34 is able to respond regardless of whether the operating system is installed, regardless of the power state, and regardless of the operational state of the installed operating system.

Referring to FIG. 4, the management framework software 49 initially requests a hardware asset information report over a network 12 as indicated in block 52. The request may be a parallel or a series request for such information from a large number of network connected processor-based systems 10, all as indicated in block 52. Referring to block 54, the management framework then receives the information from the operating system independent agents on each system 10.

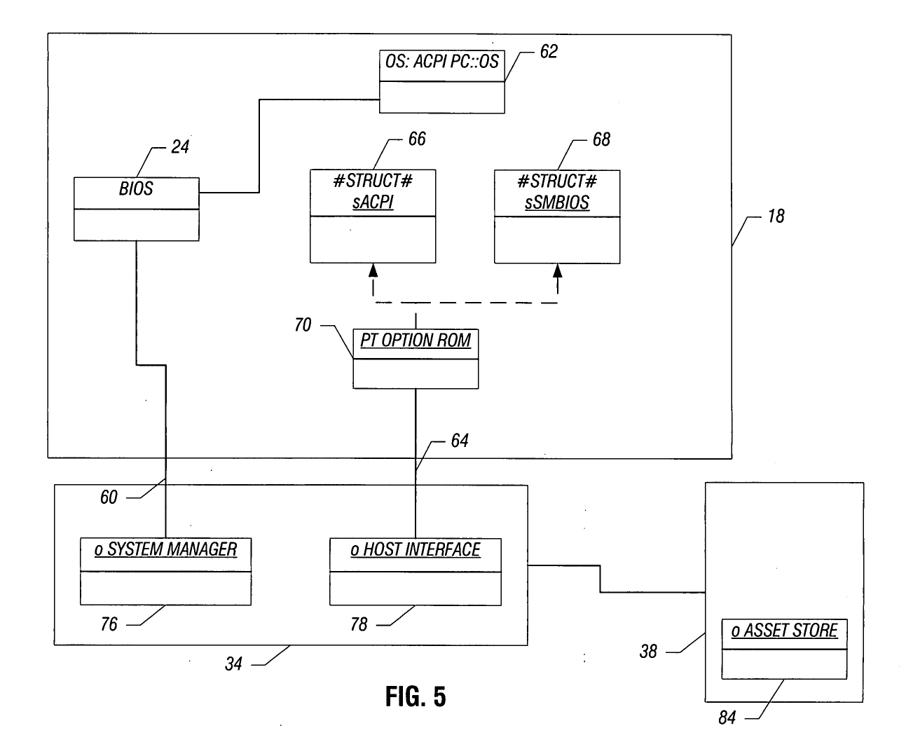

Referring to FIG. 5, the software interaction between the controller 34 and the processor 18 is illustrated. The processor 18 executes the BIOS 24, which includes a file 62 that identifies the current power configuration set up on the processor-based system. In one example, that configuration may be based on the advanced configuration and power interface (ACPI). See Advanced Configuration and Power Interface specification, rev. 2.0C (Aug. 25, 2003).

The BIOS 24 and, particularly, the processor 18 may be coupled to the controller 34 by the system management bus 60. Also executing from the processor 18 are two structures. The structure 66 is for the ACPI configuration information and the other structure 68 is for the system management BIOS. Those structures may be stored in an option read only memory (ROM) 70 on the processor 18 during execution.

The controller 34 may have a SMBus interface software 76 and processor interface software 78. The controller 34 may be coupled to the storage 38 which may store the asset information 84.

The ACPI structure 66 and the SMBIOS structure 68 are the primary sources of processor system information. They are data structures stored within and built by the BIOS 24. They receive information about the configuration of the system and about any errors and, particularly, errors during the booting process.

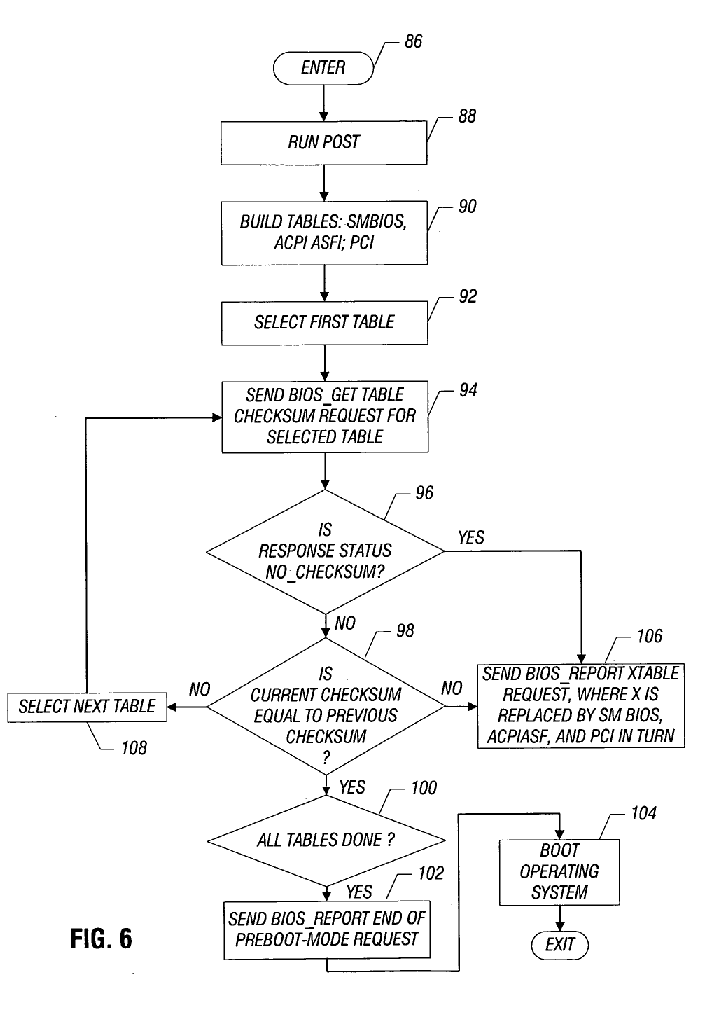

Referring to FIG. 6, in one embodiment, the software for reporting errors during the boot begins by running the power-on self-test (POST) as indicated in block 88. Tables are built for the system management BIOS, the ACPI, and the peripheral component interconnect (PCI) bus (See PCI specification, rev. 2.3 available from the PCI special interest group, Portland, Oreg. 97221), as indicated in block 90. A first table is selected, as indicated in block 92. A check sum for the requested table is requested. Since the interface 64 between the BIOS 24 and the system management agent 34 is slow, changes are detected between the current processor system configuration information and the stored information in the storage 38. To this end, a check sum is used. A complete reporting and storage of system information only occurs if the current information has changed from what has been stored, as indicated by the check sum.

Thus, a check at diamond 96 determines whether the check sum has changed. If so, the changed information is reported to the operating system independent agent 34. Otherwise, the flow continues to determine whether the current check sum is equal to the previous check sum as determined in diamond 98. If not, again, the information is reported. If it is, a check determines whether all the tables have been completed in diamond 100. If not, the flow iterates to the next table. If all of the tables have been examined, a report is sent to the operating system independent agent 34 as indicated in block 102. Thereafter, the system boot can be implemented as indicated in block 104.

The information collected may enable diagnosis of problems on particular systems 10, repairs of problems on systems 10, or detection of deployment usages. This information may add value by allowing significant savings in repair and deployment costs. In addition, the management network 14 can determine the make and model of a non-booting system 10 over the network 12. The management framework 14 may push a make or model specific diagnostic to the non-booting system 10 over the network 12 as indicated in block 56. This allows the management framework 14 to remotely diagnose a problem, saving the time and costs of a desk side visit for purposes of system diagnosis.

For example, a boot failure of the system 10 can be diagnosed remotely. The controller 32 receives initialization error indications associated with a memory failure on the SMBus 60. If the BIOS fails to initialize memory, a failure indication is sent over the network 12. The asset information may be used to then determine what memory module failed. Then the technician may determine what part is needed.

A hardware failure may also be remotely diagnosed. For example, knowing the make and model of the hard disk drive and knowing that the hard disk drive has failed at initialization, the appropriate replacement part may be provided. When the operating system fails to boot, the BIOS reports the failure over the SMBus 60. The controller 32 receives error indications over the SMBus 60, in one embodiment.

In addition, automation tools may be used to identify the make and model of systems 10 coupled through a network 12 prior to installation of an operating system. Prior to operating system installation, deployment tools may be able to couple to the system 10 to download the make and model and integrated device list. With this information, the management framework 14 may build an approved operating system image for the new system 10 and push the image to the new system over the network 12 as also indicated in block 56.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
obtaining information from a processor based system; and
reporting said information over a network while said system is non-operational.

2. The method of claim 1 wherein obtaining information includes operating an operating system independent agent to collect the information.

3. The method of claim 2 including running said agent on a microcontroller.

4. The method of claim 2 including running said agent on an independent thread.

5. The method of claim 1 wherein obtaining information includes obtaining information about the identity of the processor-based system.

6. The method of claim 1 including reporting information when the system is powered down.

7. The method of claim 1 including reporting information while the system is in a powered off state.

8. The method of claim 1 wherein obtaining information includes storing the information until such time as the information is requested over a network.

9. The method of claim 1 including receiving an error indication via a system management bus.

10. An article comprising a medium storing instructions that, if executed, enable a processor-based system to:
obtain information from the processor-based system; and
report said information over a network while said system is non-operational.

11. The article of claim 10 further storing instructions that, if executed, enable the processor-based system to operate an operating system independent agent to collect the information.

12. The article of claim 11 further storing instructions that, if executed, enable the processor-based system to run said agent on a microcontroller.

13. The article of claim 11 further storing instructions that, if executed, enable the processor-based system to run said agent on an independent thread.

14. The article of claim 10 further storing instructions that, if executed, enable the processor-based system to obtain information about the identity of the processor-based system.

15. The article of claim 10 further storing instructions that, if executed, enable the processor-based system to report information when the system is powered down.

16. The article of claim 10 further storing instructions that, if executed, enable the processor-based system to report information while the system is in a powered off state.

17. The article of claim 10 further storing instructions that, if executed, enable the processor-based system to store the information until such time as the information is requested over a network.

18. The article of claim 10 further storing instructions that, if executed, enable the processor-based system to receive an error indication via a system management bus.

19. A system comprising:
a processor; and
a storage coupled to said processor, said storage storing instructions that, if executed, enable said processor to obtain information from the system and report said information over a network while the system is non-operational.

20. The system of claim 18 wherein said system includes a first processor and a second processor, said second processor to report information from said system while the system is non-operational.

21. The system of claim 20 wherein said second processor is a microcontroller.

22. The system of claim 21, said microcontroller to execute an operating system independent agent.

23. The system of claim 20 including separate power supplies for the processors.

24. The system of claim 19, said processor to operate an operating system independent execution thread.

25. The system of claim 19, said storage further storing instructions to obtain information about the identity of said system.

26. The system of claim 19, said storage storing instructions to obtain said information when the system is powered down.

27. The system of claim 19, said storage storing instructions to report said information while the system is powered off.

28. The system of claim 19 including an auxiliary power supply for operating said processor.

29. The system of claim 21 wherein said microcontroller is coupled to the system management bus.

30. A method comprising:
querying a plurality of computer systems over a network for hardware asset information;
receiving said information from operating system independent agents on said systems; and
providing system specific information to said systems.

31. The method of claim 29 including providing diagnostic information specific to a particular system.

32. The method of claim 29 including providing an image specific to a specific system.

33. The method of claim 29 including receiving identity information from said operating system independent agent.

34. An article comprising a medium storing instructions that, if executed, enable a processor-based system to:
query a plurality of computer systems over a network for hardware asset information;
receive said information from operating system independent agents on said systems; and
provide system specific information to said systems.

35. The article of claim 34 further storing instructions that, if executed, enable said processor-based system to provide diagnostic information specific to a particular computer system.

36. The article of claim 34 further storing instructions that, if executed, enable said processor-based system to provide an image specific to a specific computer system.

37. The article of claim 34 further storing instructions that, if executed, enable the processor-based system to receive identity information from said operating system independent agent.

38. A system comprising:
a processor; and
a storage storing instructions that, if executed, enable said processor to query a plurality of computer systems over a network for hardware asset information, receive said information from operating system independent agents on said systems and provide system specific information to said systems.

39. The system of claim 38 wherein said storage stores instructions that, if executed, enable said processor-based system to provide diagnostic information specific to a particular computer system.

40. The system of claim 38 wherein said storage stores instructions that, if executed, enable said processor-based system to provide an image specific to a specific computer system.
